(19) United States
(12) Patent Application Publication
(10) Pub. No.: US 2014/0197560 A1
(43) Pub. Date: Jul. 17, 2014

(54) PRODUCTION OF CARBON-FIBER REINFORCED COKE

(71) Applicant: SGL CARBON SE, Wiesbaden (DE)

(72) Inventors: WILHELM FROHS, MEITINGEN (DE); FELIX ECKSTORFF, MEITINGEN (DE)

(73) Assignee: SGL CARBON SE, Wiesbaden (DE)

(21) Appl. No.: 14/211,001

(22) Filed: Mar. 14, 2014

Related U.S. Application Data
(63) Continuation of application No. PCT/EP2012/055950, filed on Apr. 2, 2012.

(30) Foreign Application Priority Data
Sep. 14, 2011 (DE) 102011082699.8

(51) Int. Cl. C04B 35/83

(52) U.S. Cl. CPC C04B 35/83
USPC 264/29.1

(57) ABSTRACT

A method produces carbon fiber-reinforced coke. Carbon fiber-reinforced plastic (CFRP) materials derived from components and semi-finished products are continuously fed through a top side of the drum of a delayed coker as a partial flow or as a main flow, and the CFRP materials sink through the gas phase into the still liquid phase. The carbon fibers are released through carbonization of the resin matrix and incorporated therein during the coking process. The decomposition products of the resin matrix are supplied to a material recovery process.

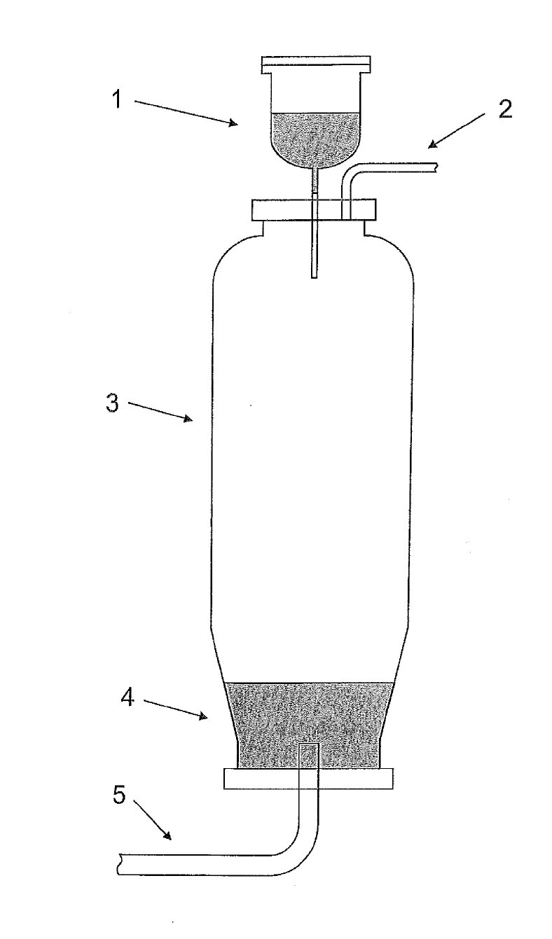

### CROSS-REFERENCE TO RELATED APPLICATION

This is a continuation application, under 35 U.S.C. §120, of co-pending international application PCT/EP2012/055950, filed Apr. 2, 2012, which designated the United States; this application also claims the priority, under 35 U.S.C. §119, of German patent application DE 10 2011 082 699.8, filed Sep. 14, 2011; the prior applications are herewith incorporated by reference in their entirety.

### BACKGROUND OF THE INVENTION

### Field of the Invention

The invention relates to a method for using carbon fiber-reinforced plastic (CFRP) materials derived from components and semi-finished products for producing carbon fiber-reinforced coke, preferably needle coke. In this case, a smaller fraction of CFRP materials which have previously been comminuted is coked with a larger fraction of heavy refinery residue or coal tar and/or coal tar pitch.

A delayed coker is a device of a petroleum refinery in which high-molecular viscous residues are coked (delayed coking method). The delayed coker substantially consists of two units, a continuous flow heater (coker furnace) and two coker drums which are acted upon alternately. In a continuous-flow heater the residues are preferably heated to about 500-600° C., particularly preferably to 500-550° C. The coker drums are operated at a pressure of at most 0.9 MPa.

In U.S. Pat. No. 7,276,284 it is described that carbon fiber reinforced coke is produced by joint coking of a mixture of a smaller fraction of cut carbon fibers and a larger fraction of viscous refinery residues or coal tar and coal tar pitch. Here carbon fibers are mixed into the stream of incoming input materials for the delayed coking method, where the input materials consist, for example, of the group of highly aromatic residues from vacuum distillation, and subsequent coking of the mixture in a delayed coker.

The product, petroleum coke, is produced from distillation or conversion residue which is pumped at elevated pressure and at elevated temperature from the underside into a coker drum, where the residue decomposes and a coke layer growing from bottom to top is formed.

On the one hand, the difficult metering of primary or fresh short-cut fibers (virgin fibers) due to the tendency towards splitting and subsequent nest formation, agglomeration and felting proves to be disadvantageous both in the pure state and also during convection in the liquid phase since the C fibers are only joined to one another by a smaller fraction of black wash.

In addition, the forming coke bed has a filter effect on the fibers which are pumped with the input material from below into the coker drum since the porosity impedes a further penetration of the fibers into the coke bed and prevents a further homogeneous distribution of the fibers.

Furthermore, the high manufacturing costs of primary fibers bear no relation to the usual sales prices on the market of coke for graphite production with the result that an industrial application is not economically appropriate.

### SUMMARY OF THE INVENTION

It is the object of the present invention to achieve a homogeneous distribution of carbon fibers in the horizontal and vertical direction in the coke.

The object is solved by continuous metering of CFRP materials through the top side of the drum of a delayed coker as a partial stream or as a main stream, where the CFRP materials sink through a gas phase into a still liquid phase and during a solid phase conversion a resin matrix carbonizes and released carbon fibers are incorporated into the forming coke matrix.

CFRP materials in the sense of this invention are understood as any components, semi-finished products, in particular rejects or residual quantities from the production of CFRP semi-finished products or components, furthermore material from the end-of-life recycling of, for example, automobile bodies, aircraft components and other CFRP components.

The CFRP materials in the sense of this invention are characterized in that they have a carbon fiber fraction in the range of 30-60 wt. %, accordingly the coke matrix fraction is 40-70%. The coke matrix preferably contains a thermosetting or a thermoplastic polymer.

The CFRP materials can contain foreign fibers such as glass fibers and/or polymer fibers as an additional component. Ash-forming components in a content up to 10 wt. % have no perturbing effect on the process product, the carbon fiber-reinforced coke.

By means of suitable comminution methods such as, for example, shredding, cutting or grinding, it is possible to produce CFRP particles which are characterized by good metering behavior. The CFRP materials are preferably classified before the metering by sieving or sifting processes if these have an inhomogeneous size and shape distribution. The CFRP particles have a preferred length of 100 pm to 100 mm and a form factor of preferably between 0.1 and 0.8 and particularly preferably between 0.1 and 0.5.

The CFRP materials are metered via the top side of the coker drum either as a solid and/or as a solid-liquid suspension with a carrier fluid, in the case of a solid-liquid suspension preferably with a viscous refinery product as a carrier fluid. The concentration of CFRP material in the carrier fluid is between 10 wt. % and 60 wt. %.

The CFRP materials sink in the coker drum through the gas phase onto the still-liquid phase. During the solid phase conversion the resin matrix of the CFRP cokes and releases the carbon fibers which are incorporated in the forming coke matrix.

An essential advantage of the CFRP materials according to the invention compared with primary or fresh short-cut fibers (virgin fibers) consists in that a high resin fraction ensures that after the preferred comminution to CFRP particles, the CFRP materials are present in the form of compact pieces which do not split during metering and do not form any unmeterable fiber balls, or do not felt.

The crucial advantages of the CFRP particles are the sinking against the ascending gas stream in the delayed coker and thus reaching the surface of the highly aromatic residues coking in the coker and the release of the fibers due to the extensive volatilization of the polymer matrix under the prevailing conditions of about 500° C. The comparatively high polymer matrix fraction of the particles is advantageous for this behavior. The CFRP particles are preferably added continuously over the entire filling time of the coker in order to optimize the homogeneous distribution in the entire quantity of coke.

Since the fibers reach the liquid phase and are not removed via the gas outlet of the delayed coker, it is ensured that no downstream further process steps or parts of the installation are negatively adversely influenced.

As soon as the CFRP particles reach the liquid phase, the polymer matrix of the fibers is decomposed due to the temperature prevailing in the delayed coker and as a result, the individual fibers are released. This together with the convection in the delayed coker in the liquid phase ensures that the fibers are embedded in the coke matrix homogeneously dispersed in the horizontal direction.

The organic CFRP particle shape guarantees the fiber cohesion and not only enables a comparatively simple metering but also facilitates the homogeneous incorporation of the carbon fibers in the coke matrix forming in the coker.

The decomposition products of the polymer fraction together with the decomposition products from the delayed coker are transferred into a fractionating column and processed there.

Another advantage of the method according to the invention consists in that the decomposition products of the polymer matrix do not adversely affect the quality of the gaseous and liquid products from the delayed coker and therefore are accessible to a material recovery process within the framework of refinery products.

Particularly preferably the green coke removed from the drum is used for poly granular carbon and/or graphite bodies. Preferably graphite electrodes and connecting pieces are produced by shaping processes, for example, extrusion or shaking process. The bodies thus produced have a preferred direction (anisotropy), where elongate components, i.e. also carbon fibers or elongated carbon grains with carbon fibers contained therein are aligned in the direction of extrusion.

The carbon fiber-reinforced coke and therefore the poly granular carbon and/or graphite bodies particularly preferably produced there from have properties which are influenced by the carbon fibers contained therein. Favorable thermal coefficients of expansion, high strength or an improved modulus of elasticity, in particular fracture toughness are achieved in the following preferably used poly granular carbon and/or graphite bodies: graphite electrodes, connecting pieces (nipples), fine-grained and reactor graphite, cathodes for aluminum electrolysis, furnace linings, aluminum bricks, carbon bricks for lining blast furnaces for steel production and other furnace linings.

Other features which are considered as characteristic for the invention are set forth in the appended claims.

Although the invention is illustrated and described herein as embodied in a production of carbon fiber reinforced coke, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single figure of the drawing is an illustration of a coker drum assembly according to the invention.

### DETAILED DESCRIPTION OF THE INVENTION

Referring now to the single figure of drawing in detail, a process sequence according to the invention is explained as an example. CFRP particles are continuously metered with a fiber metering unit 1 via a top side of a coker drum 3 of a delayed coker. When hot refinery residue (coker furnace not shown here) enters from an underside of the coker drum 3 of the delayed coker via an oil inlet 5 from the coker furnace, a coke bed formation 4 is initiated while volatile components and decomposition products escape via the outlet for gaseous products 2 to the fractionating column. For further details of the process sequence, reference is made to the following example.

A reject component made of CFRP from the vehicle industry is ground and sieved such that CFRP particles in a size range of 10 to 20 mm are obtained. The CFRP component has a fraction of glass fibers of 2.5 volume %. The CFRP particles are metered continuously via the top side of the drum 3 of a delayed coker where they meet the incoming stream of input materials of the delayed coker.

Input material for coke production is a highly aromatic refinery residue from a fluid catalytic cracker (FCC). This heavy oil initially runs through the continuously operated coker furnace where it is heated to 550° C. at 0.4 to 0.5 MPa and a residence time of maximum 3 minutes and then the fraction of the process taking place in batch mode in the coker drum. Hot vapor promotes the conveying effect of the oil.

When the hot residue enters from the underside of the drum of the delayed coker, coke formation taking place via the mesophase is initiated while volatile components and decomposition products escape and are separated by a distillation column and partially fed back to the coker. While the coke layer grows continuously from below, the fiber particles are metered dry.

The coke drum 3 is mostly filled up to a residual height of a few meters from the upper edge within about 24 hours. The inflow for the drum 3 is then interrupted and deflected to a second, empty drum.

The metering speed of the CFRP particles is adjusted so that the fraction of carbon fibers in the total coke mass is 3%. During the process the carbon fibers are distributed homogeneously in the highly aromatic refinery residue or after solidification into a green coke.

The mode of operation of the delayed coker determines the quality of the coke formed, preferably needle coke, which contains carbon fibers according to the invention. The green coke is removed from the drum and particularly preferably used to produce poly granular carbon bodies, where heating (calcining) is carried out to temperatures of up to 1400° C.

The following is a summary list of reference numerals and the corresponding structure used in the above description of the invention:
1 Fiber metering unit
2 Outlet for gaseous products (to fractionating column)
3 Coker drum
4 (Fiber) coke bed
5 Oil inlet (from coker furnace)

1. A method for producing carbon fiber-reinforced coke, which comprises the steps of:
continuously metering carbon fiber-reinforced plastic (CFRP) materials derived from components and semi-finished products through a top side of a drum of a delayed coker as a partial stream or as a main stream, the CFRP materials sink through a gas phase into a still liquid phase and during a solid phase conversion, a resin matrix carbonizes and released carbon fibers are incorporated into a forming coke matrix.

2. The method for producing the carbon fiber-reinforced coke according to claim 1, which further comprising forming the CFRP materials to have a carbon fiber fraction in a range of 30-60 wt. %.

3. The method for producing the carbon fiber-reinforced coke according to claim 1, wherein the coke matrix contains a thermosetting polymer or a thermoplastic polymer.

4. The method for producing the carbon fiber-reinforced coke according to claim 1, which further comprises classifying the CFRP materials before the metering.

5. The method for producing the carbon fiber-reinforced coke according to claim 4, which further comprises comminuting the CFRP materials before the metering and/or classifying to form CFRP particles that are present in compact pieces.

6. The method for producing the carbon fiber-reinforced coke according to claim 1, which comprises supplying the CFRP materials continuously over an entire filling time of the delayed coker.

7. The method for producing the carbon fiber-reinforced coke according to claim 5, which further comprises setting a length of the CFRP particles to be 100 μm to 100 mm and having a form factor of 0.1 to 0.8.

8. The method for producing the carbon fiber-reinforced coke according to claim 1, wherein the metering takes place in the delayed coker as a solid and/or a solid-liquid suspension with a carrier fluid.

9. The method for producing the carbon fiber-reinforced coke according to claim 8, which further comprises setting a concentration of the CFRP materials in the carrier fluid to be between 10 wt. % and 60 wt. %.

10. The method for producing the carbon fiber-reinforced coke according to claim 1, which further comprises transferring decomposition products of a polymer fraction together with decomposition products from the delayed coker into a fractionating column and processed there.

11. A production method, which comprises the steps of:
producing a carbon fiber-reinforced coke by continuously metering carbon fiber-reinforced plastic (CFRP) materials derived from components and semi-finished products through a top side of a drum (3) of a delayed coker as a partial stream or as a main stream, the CFRP materials sinking through a gas phase into a still liquid phase and during a solid phase conversion, a resin matrix carbonizes and released carbon fibers are incorporated into a forming coke matrix; and
removing green coke from the drum for making poly granular carbon and/or graphite bodies.

12. The production method according to claim 11, which further comprises forming the poly granular carbon and/or the graphite bodies into at least one of graphite electrodes, connecting pieces (nipples), fine-grained and reactor graphite, cathodes for aluminum electrolysis, furnace linings, aluminum bricks, carbon bricks for lining blast furnaces for steel production or other furnace linings.
